(19) United States
(12) Patent Application Publication
(10) Pub. No.: US 2020/0005754 A1
(43) Pub. Date: Jan. 2, 2020

(54) METHOD OF PRODUCING VIBRATION DAMPING AND SOUND ABSORBING FOAM

(71) Applicant: Sumitomo Riko Company Limited, Komaki-shi (JP)

(72) Inventors: Kunio Ito, Komaki-shi (JP); Motoshige Hibino, Komaki-shi (JP); Takahiro Kachi, Komaki-shi (JP); Shinsuke Asai, Komaki-shi (JP); Keiichi Muratani, Komaki-shi (JP)

(73) Assignee: Sumitomo Riko Company Limited, Komaki-shi (JP)

(21) Appl. No.: 16/567,145

(22) Filed: Sep. 11, 2019

Related U.S. Application Data
(63) Continuation of application No. PCT/JP2018/047541, filed on Dec. 25, 2018.

(30) Foreign Application Priority Data
Dec. 27, 2017 (JP) 2017-250735

(51) Int. Cl. G10K 11/162; B29C 44/34; B29C 44/56; C08L 75/08; C08G 18/48; C08G 18/76; C08J 9/00; C08J 9/12; C08J 9/38; C08K 3/40; C08K 3/08; C08K 7/18; C08K 9/04

(52) U.S. Cl. CPC G10K 11/162; B29K 2075/00; B29C 44/5627; C08L 75/08; C08G 18/4829; C08G 18/7614; C08G 18/7671; C08J 9/0066; C08J 9/009; C08J 9/0061; C08J 9/125; C08J 9/38; C08K 3/40; C08K 3/08; C08K 7/18; C08K 9/04; B29C 44/3442

(57) ABSTRACT

Vibration damping and sound absorbing foam formed of foam and fine particles present inside the foam so as to form bell-like structures in the foam is produced by performing the following steps [I] to [III] in the stated order. [I] Producing fine particles each having a surface coated with a coating material capable of being dissolved in at least one liquid selected from water and a solvent. [II] Mixing the coated fine particles into a material for foam, and producing foam from the mixture. [III] Immersing the foam in at least one liquid selected from water and a solvent to remove the coating of each of the fine particles in the foam by dissolution in the liquid.

### RELATED APPLICATION

This application is a continuation of International Application No. PCT/JP2018/047541, filed on Dec. 25, 2018, which claims priority to Japanese Patent Application No. 2017-250735, filed on Dec. 27, 2017, the entire contents of each of which being hereby incorporated by reference.

### TECHNICAL FIELD

The present disclosure relates to a method of producing vibration damping and sound absorbing foam, and more specifically, to a method of producing vibration damping and sound absorbing foam to be used as, for example, vibration damping and sound absorbing foam for housing, vibration damping and sound absorbing foam for an automobile, vibration damping and sound absorbing foam for Office Automation equipment, vibration damping and sound absorbing foam for a railroad, or vibration damping and sound absorbing foam for a road or a bridge.

Hitherto, in a housing building, transmission of sounds between upper and lower floors has been perceived as a problem. The sounds to be perceived as a problem in the housing building are generated from various sources, and hence it is difficult to take a countermeasure against all the sounds through use of one member. Therefore, in general, members specialized in reducing sounds in respective frequency regions are used in combination in order to carry out a countermeasure against all audible regions. For example, in a low-frequency region of from 10 Hz to 1,000 Hz, a sound reducing effect exhibited by a sound absorbing material is low, and hence a vibration countermeasure is mainly carried out. In a high-frequency region of 1,000 Hz or more, a sound countermeasure based on a sound absorbing material or a sound insulating material is carried out.

Specific examples of the vibration countermeasure include (1) an increase in rigidity of a building frame, (2) an increase in weight of concrete or the like, (3) placement of an anti-vibration rubber that does not transmit vibration, and (4) mounting of a vibration damping material.

Meanwhile, specific examples of the sound reducing countermeasure based on a sound absorbing material or a sound insulating material include (1) attachment of a sound insulating sheet, (2) placement of a box configured to confine sound, and (3) application of glass wool.

In general, a countermeasure in the housing building is taken by taking a vibration countermeasure and a sound countermeasure based on a combination of the above-mentioned various members.

Incidentally, in recent years, as a member for taking both of the vibration countermeasure and sound countermeasure as described above, there has been proposed a sound insulating plate or the like having many internal closed pores and having bell-like structures including, in the pores, inorganic fine particles that can independently move (see PTL 1 and PTL 2).

### RELATED ART DOCUMENTS

### Patent Documents

PTL 1: JP-B2-2818862

PTL 2: JP-A-2006-335918

### SUMMARY

The sound insulating plate having the bell-like structures as described above provides a certain vibration damping effect on the basis of: a vibration damping effect based on vibration and collision of the inorganic fine particles in the pores (impact damper effect); and a vibration damping effect based on the deformation of a resin or the like forming the sound insulating plate caused by the weight of the inorganic fine particles (mass damper effect). In addition, when the sound insulating plate is made of foam, a certain sound absorbing effect is also provided. Thus, the sound insulating plate having the bell-like structures as described above is recognized as exhibiting certain effects as a member for taking both of a vibration countermeasure and a sound countermeasure.

However, in each of PTL 1 and PTL 2 described above, the bell-like structures are formed by coating the surfaces of the inorganic fine particles with a foaming agent, and then mixing the inorganic fine particles into the resin serving as a material for the sound insulating plate, followed by foaming of the foaming agent on the surfaces of the inorganic fine particles, and hence it is difficult to adjust pore diameters in the bell-like structures. Accordingly, in such production method, it is difficult to form uniform bell-like structures, and the difficulty poses an obstacle in achieving both of a vibration countermeasure and a sound countermeasure.

Meanwhile, when the inorganic fine particles are merely mixed into the material for the foam, the bell-like structures as described above are not successfully formed. Accordingly, it is difficult to achieve both of a desired vibration countermeasure and a desired sound countermeasure by this technique.

The present disclosure has been made in view of such circumstances, and provides a method of producing vibration damping and sound absorbing foam by which vibration damping and sound absorbing foam capable of achieving both of a vibration countermeasure and a sound countermeasure, and capable of taking a countermeasure against sounds ranging widely from a low frequency to a high frequency can be satisfactorily produced.

The gist of the present disclosure relates to a method of producing vibration damping and sound absorbing foam formed of foam and fine particles present inside the foam so as to form bell-like structures in the foam, the method including the following steps [I] to [III] in the stated order:

[I] a step of producing fine particles each having a surface coated with a coating material capable of being dissolved in at least one liquid selected from water and a solvent;

[II] a step including mixing the coated fine particles into a material for foam, and producing foam from the mixture; and

[III] a step of immersing the foam in at least one liquid selected from water and a solvent to remove the coating of each of the fine particles in the foam by dissolution in the liquid.

The inventors have made extensive investigations in order to solve the above-mentioned problem. In the course of the investigations, the inventors have obtained the following finding. When fine particles are caused to be present inside foam so as to form bell-like structures in the foam, and besides, the bell-like structures are uniformly formed, both of a vibration countermeasure and a sound countermeasure are satisfactorily achieved. Then, the inventors have made extensive investigations on a production method by which vibration damping and sound absorbing foam having such bell-like structures can be satisfactorily produced. As a result, the inventors have conceived of: producing fine particles each having a surface coated with a material capable of being dissolved in a liquid, such as water (e.g., a rubber, resin, or ionic inorganic material capable of being dissolved in the liquid); mixing the fine particles into a material for the foam, and producing the foam; and then immersing the foam in a liquid, such as water, to remove the coating of each of the fine particles in the foam by dissolution while repeatedly applying compression to the foam as appropriate. The inventors have found that the thus obtained vibration damping and sound absorbing foam is easily allowed to have uniform bell-like structures by specifying the particle diameter of each of the fine particles and specifying the thickness of the coating to be applied to the surface of each of the fine particles, and as a result, the desired object can be achieved.

As described above, the method of producing vibration damping and sound absorbing foam of the present disclosure includes: the step of producing fine particles each having a surface coated with a material capable of being dissolved in a liquid, such as water (step [I]); the step including mixing the coated fine particles into a material for foam, and producing foam from the mixture (step [II]); and the step of immersing the foam in a liquid, such as water, to remove coating of each of the fine particles in the foam by dissolution in the liquid (step [III]). Accordingly, the vibration damping and sound absorbing foam having uniform bell-like structures in the foam, capable of achieving both of a vibration countermeasure and a sound countermeasure, and capable of taking a countermeasure against sounds ranging widely from a low frequency to a high frequency can be satisfactorily produced.

In particular, when the material for the foam to be used includes at least one of ether polyurethane and ester polyurethane, the vibration damping and sound absorbing foam for taking both of a vibration countermeasure and a sound countermeasure can be more satisfactorily produced.

In addition, when the fine particles to be used include at least one selected from the group consisting of metal fine particles, resin fine particles, and inorganic fine particles, the vibration damping and sound absorbing foam for taking both of a vibration countermeasure and a sound countermeasure can be more satisfactorily produced.

Further, when the liquid to be used includes water, the vibration damping and sound absorbing foam for taking both of a vibration countermeasure and a sound countermeasure can be more satisfactorily produced.

In addition, when the coating material to be used includes at least one selected from the group consisting of a rubber, a resin, and an ionic inorganic material each of which is capable of being dissolved in at least one liquid selected from water and a solvent, the vibration damping and sound absorbing foam for taking both of a vibration countermeasure and a sound countermeasure can be more satisfactorily produced.

Further, when the method further includes, between the step [II] and the step [III], a step of blowing air against a surface of the foam to crush the foam, the openings of the communication paths to the bell-like structures are likely to appear on the surface of the foam, and hence the step [III] can be more favorably performed.

In addition, when the step [III] is performed by repeatedly compressing the foam in the liquid, the step [III] can be more favorably performed.

### BRIEF DESCRIPTION OF DRAWINGS

FIG. 1 is an explanatory view for schematically illustrating bell-like structures in vibration damping and sound absorbing foam according to the present disclosure.

FIG. 2 is a scanning electron microscope (SEM) photograph of a cross-section of a sample of the vibration damping and sound absorbing foam according to the present disclosure, and is a photograph of fine particles forming the bell-like structures in the foam.

### DESCRIPTION OF EMBODIMENTS

Next, embodiments of the present disclosure are specifically described.

A method of producing vibration damping and sound absorbing foam of the present disclosure includes: a step of producing fine particles each having a surface coated with a coating material capable of being dissolved in at least one liquid selected from water and a solvent (step [I]); a step including mixing the coated fine particles into a material for foam, and producing foam from the mixture (step [II]); and a step of immersing the foam in at least one liquid selected from water and a solvent to remove the coating of each of the fine particles in the foam by dissolution in the liquid (step [III]). Accordingly, vibration damping and sound absorbing foam having uniform bell-like structures in the foam, capable of achieving both of a vibration countermeasure and a sound countermeasure, and capable of taking a countermeasure against sounds ranging widely from a low frequency to a high frequency can be satisfactorily produced. In the vibration damping and sound absorbing foam obtained as described above, it is desired that bell-like structures having communication paths communicating to the surface of the foam be formed, rather than bell-like structures in which fine particles are present inside closed pores, from the viewpoint of achieving both of a vibration countermeasure and a sound countermeasure. In addition, also from the viewpoint of efficiently performing the step [III], it is desired that the bell-like structures having communication paths communicating to the surface of the foam be formed.

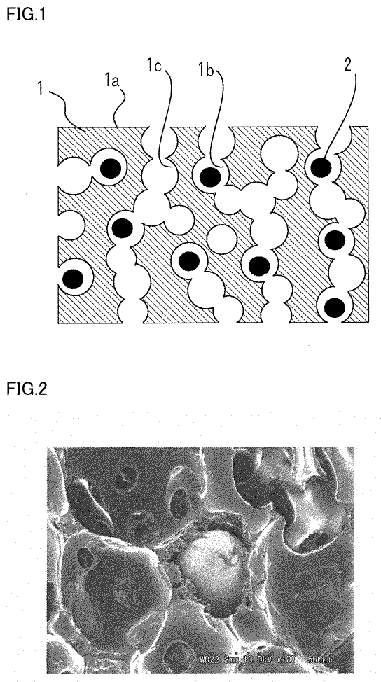

When schematically illustrated, the bell-like structures in the vibration damping and sound absorbing foam are as illustrated in FIG. 1. In FIG. 1, reference symbol 1 denotes foam, reference symbol 1a denotes a foam surface, reference symbols 1b and 1c each denote a cell, and reference symbol 2 denotes a fine particle. In addition, such bell-like structures may be identified by, for example, observing a cross-section of the vibration damping and sound absorbing foam with a scanning electron microscope (SEM). FIG. 2 is an actual scanning electron microscope (manufactured by Hitachi, Ltd., SEMEDX TYPE N, magnification: 100 times) photograph of a cross-section of the vibration damping and sound absorbing foam according to the present disclosure. In FIG. 2, pores are formed in the foam, not in a general foamed cell shape, but in the shape of the dissolved coating of the fine particle, and hence it can be confirmed that bell-like structures containing fine particles have been formed in the foam through the dissolution.

Cells in the foam 1 that are illustrated in FIG. 1 include cells forming bell-like structures containing the fine particles 2 (cells 1b), and cells that do not contain the fine particles 2 (cells 1c). Of those, the cells 1c, which do not contain the fine particles 2, are mainly formed by foaming of the foam 1 itself, and the cells 1b, which contain the fine particles 2, are mainly formed by the removal of the coating of each of the fine particles 2 by dissolution. In addition, as illustrated in FIG. 1, the cells 1b, which contain the fine particles 2, are configured to communicate (have communication paths) to the foam surface 1a. Patterns of the communication of the cells 1b to the foam surface 1a include: (1) a case in which the cells 1b are directly connected to the foam surface 1a; (2) a case in which the cells 1b are connected to the foam surface 1a via the cells 1c; and (3) a case in which the communication paths are formed by repeatedly compressing the foam 1 to connect the cells to each other, or by blowing air against the foam surface 1a to crush the foam. The bell-like structures can be allowed to be uniform bell-like structures by specifying the particle diameter of each of the fine particles 2 and specifying the thickness of the coating to be applied to the surface of each of the fine particles 2.

In addition, the bell-like structures as illustrated in FIG. 1 enhance a vibration damping effect by exhibiting a vibration damping effect based on vibration and collision of the fine particles 2 in the bell-like structures (impact damper effect), and a vibration damping effect based on the deformation of the foam 1 caused by the weight of the fine particles 2 (mass damper effect). Further, the cells 1b and other cells 1c in the bell-like structures communicate to the surface of the foam 1, and hence a sound absorbing effect is also enhanced.

From the viewpoint of taking both of a vibration countermeasure and a sound countermeasure, a weight ratio between the foam 1 and the fine particles 2 in the vibration damping and sound absorbing foam according to the present disclosure is preferably as follows: weight of the fine particles 2/weight of the foam 1=0.1 to 200. In addition, from the above-mentioned viewpoint, the cell diameter of each of the cells 1b is preferably from 50 μm to 5,000 μm, and more preferably falls within the range of from 100 μm to 800 μm. The cell diameter of each of the cells 1c is preferably from 50 μm to 1,000 μm, and more preferably falls within the range of from 100 μm to 800 μm. Those cell diameters are each determined by sampling about 20 largest corresponding cells and calculating an average value for their cell diameters. For each of oval cells, a value obtained by dividing the sum of its longest diameter and shortest diameter by 2 is defined as the cell diameter.

Next, the steps in the method of producing vibration damping and sound absorbing foam of the present disclosure are described one by one.

<Step [I]>

The step [I] is a step of producing fine particles each having a surface coated with a coating material capable of being dissolved in at least one liquid selected from water and a solvent. The solvent refers to: a hydrocarbon solvent, such as cyclohexane, n-hexane, toluene, or xylene; an alcohol solvent, such as methanol, ethanol, isopropyl alcohol, butanol, or cyclohexanol; a ketone solvent, such as acetone, methyl ethyl ketone, methyl isobutyl ketone, or cyclohexanone; an ester solvent, such as ethyl acetate, butyl acetate, isobutyl acetate, amyl acetate, propylene glycol monoethyl ether acetate, or ethylene glycol monoethyl ether acetate; an ether solvent, such as propylene glycol monomethyl ether, cellosolve, butyl cellosolve, or tetrahydrofuran (THF); or an amide solvent, such as dimethylformamide.

In addition, examples of the coating material include a rubber, a resin, and an ionic inorganic material each of which is capable of being dissolved in at least one liquid selected from water and a solvent. Those coating materials may be used alone or in combination thereof. Specific examples of such rubber include a natural rubber, a styrene butadiene rubber, an isoprene rubber, a butadiene rubber, a chloroprene rubber, an acrylonitrile butadiene rubber, a butyl rubber, an ethylene propylene rubber, an ethylene propylene diene rubber, a urethane rubber, a silicone rubber, a fluorine rubber, an acrylic rubber, an epichlorohydrin rubber, chlorosulfonated polyethylene, and chlorinated polyethylene. In addition, specific examples of such resin include an acrylic resin, a urethane resin, a fluorine resin, a polyester resin, a silicon resin, a carbonate resin, a polyamide resin, a nylon resin, a polyether ester amide, vinyl chloride, vinylidene chloride, polyvinyl alcohol, polyvinyl acetate, polystyrene, an acrylonitrile-butadiene-styrene copolymer resin (ABS), a polyisobutylene resin, and a phenol resin. In addition, specific examples of such ionic inorganic material include sodium chloride, sodium sulfate, and sodium nitrate. In addition, as other coating materials, there are given, for example, cellulose, sucrose, proteins, starches, peptides, and polyphenols. Whether each of those coating materials is capable of being dissolved or not is determined based on its combination with a liquid to be used.

In addition, metal fine particles, resin fine particles, inorganic fine particles, and the like are used alone or in combination thereof as the fine particles. As the metal fine particles, fine particles formed of iron, zinc, stainless steel, aluminum, copper, silver, or the like are used. As the resin fine particles, fine particles formed of polypropylene, polyethylene, acryl, urethane, polyamide (nylon), melamine, or the like, or fluorine resin fine particles or styrene rubber fine particles are used. As the inorganic fine particles, fine particles formed of glass, zircon, zirconia, silicon carbide, silica, magnesium oxide, calcium carbonate, or a metal oxide, such as titanium oxide or zinc oxide, are used. As other fine particles, plant fine particles, such as a walnut shell pulverized product, are used. Of those fine particles, fine particles formed of stainless steel and glass beads are preferred from the viewpoints of rust resistance and high specific gravity.

In addition, from the viewpoint of vibration damping and sound absorbing property, the specific gravity of the fine particles is preferably from 0.9 to 12, more preferably from 2 to 8. Further, from the viewpoint of vibration damping and sound absorbing property, the particle diameter of each of the fine particles is preferably from 10 μm to 5,000 μm, more preferably from 100 μm to 1,000 μm. The particle diameter refers to a median diameter according to Particle size analysis-Laser diffraction methods (JIS Z 8825). In addition, the particle diameters of particles used in Examples to be described later were also measured by a similar technique.

In addition, the fine particles are coated by, for example, loading the fine particles and the coating material (appropriately diluted with a liquid, such as water) into a granulator for powder, uniformly mixing the contents by stirring, and drying the mixture in an oven. Then, the thus obtained granulated product is pulverized in a mortar or the like, and the pulverized product is passed through a sieve having a predetermined aperture to regulate particle diameters. Thus, the coated fine particles may be obtained. In addition, from the viewpoint of more satisfactorily producing vibration damping and sound absorbing foam for taking both of a vibration countermeasure and a sound countermeasure, the thickness of the coating in each of the thus obtained fine particles is preferably from 1 μm to 1,000 μm, more preferably from 10 μm to 500 μm. In addition, from the viewpoint of satisfactorily producing fine particles each having applied thereto a coating having such thickness, it is preferred that the volume of a resin component and the like in the coating material, and the volume of the fine particles therein be set to fall within the following range: volume of resin component and the like/volume of fine particles=1 to 10.

<Step [II]>

The step [II] is a step including mixing the coated fine particles into a material for foam, and producing foam from the mixture. As a polymer material for the foam, there are given, for example, polyether urethane, polyester urethane, a natural rubber, a chloroprene rubber, an ethylene propylene rubber, a nitrile rubber, a silicone rubber, a styrene butadiene rubber, polystyrene, polyolefin, a phenol resin, polyvinyl chloride, a urea resin, polyimide, and a melamine resin. Those polymer materials may be used alone or in combination thereof. Of those, ether polyurethane and ester polyurethane are preferably used from the following viewpoint: many communication paths to the surface of the foam can be formed, and hence vibration damping and sound absorbing foam for taking both of a vibration countermeasure and a sound countermeasure can be more satisfactorily produced.

When the polyurethane to be used has an NCO index of from 0.8 to 1.5, vibration damping and sound absorbing foam excellent in vibration damping and sound absorbing performance can be more satisfactorily produced.

For example, in the case of the polyurethane, a foaming agent, such as water, a chain extender, a catalyst, a foam stabilizer, a hydrolysis inhibitor, a flame retardant, a viscosity reducing agent, a stabilizer, a filler, a cross-linking agent, a colorant, or the like is blended in the material for the foam as required in addition to a polyol component thereof and an isocyanate component thereof.

In addition, the foam is obtained by subjecting the material for the foam to kneading or the like, and subjecting the resultant to heating or the like. However, when mold forming is performed in the production of the foam, a skin layer is formed on the surface of the foam, and hence the openings of the communication paths leading to the bell-like structures described above do not appear on the surface of the foam in some cases. In such cases, when air is blown against the surface of the foam to crush the foam, the openings of the communication paths to the bell-like structures are likely to appear on the surface of the foam, and hence the step [III] described below can be more favorably performed.

<Step [III]>

The step [III] is a step of immersing the foam in at least one liquid selected from water and a solvent to remove the coating of each of the fine particles in the foam by dissolution in the liquid. Examples of the solvent include: hydrocarbon solvents, such as cyclohexane, n-hexane, toluene, and xylene; alcohol solvents, such as methanol, ethanol, isopropyl alcohol, butanol, and cyclohexanol; ketone solvents, such as acetone, methyl ethyl ketone, methyl isobutyl ketone, and cyclohexanone; ester solvents, such as ethyl acetate, butyl acetate, isobutyl acetate, amyl acetate, propylene glycol monoethyl ether acetate, and ethylene glycol monoethyl ether acetate; ether solvents, such as propylene glycol monomethyl ether, cellosolve, butyl cellosolve, and tetrahydrofuran (THF); and amide solvents, such as dimethylformamide. Those solvents maybe used alone or in combination thereof. In addition, water is preferably used as the liquid because vibration damping and sound absorbing foam for taking both of a vibration countermeasure and a sound countermeasure can be more satisfactorily produced. Further, it is preferred that the dissolution removal step as described above be performed by repeatedly compressing the foam in the liquid because the dissolution removal step can be more favorably performed. Further, when the foam is repeatedly compressed in the liquid, the cells are likely to be connected to each other, and hence an effect of providing more excellent sound absorbing performance can also be expected.

The foam that has been subjected to the removal of the coating of each of the fine particles by dissolution as described above is dried as appropriate. Thus, the vibration damping and sound absorbing foam of interest can be obtained (see FIG. 1).

The vibration damping and sound absorbing foam obtained as described above is suitably used as, for example, vibration damping and sound absorbing foam for housing, vibration damping and sound absorbing foam for Office Automation equipment, vibration damping and sound absorbing foam for a railroad, or vibration damping and sound absorbing foam for a road or a bridge.

### EXAMPLES

Next, the Examples are described together with a Comparative Example. However, the present disclosure is not limited to these Examples without departing from the gist of the present disclosure.

First, polyethylene particles (manufactured by Sumitomo Seika Chemicals Co., Ltd., CL2507, particle diameter: 180 μm, specific gravity: 0.9), glass beads (manufactured by Unitika Ltd., UB-1618LNM, particle diameter: 600 μm, specific gravity: 2.5), and spherical stainless-steel particles (manufactured by Sintokogio, Ltd., SUS50B, particle diameter: 300 μm, specific gravity: 7.9) were prepared. Next, any one of the prepared particles, a water-soluble resin (manufactured by Toray Industries, Inc., AQ Nylon T-70, solid content: 50%), and ion-exchanged water were loaded into a granulator for powder (manufactured by Kawata Mfg. Co., Ltd., SUPERMIXER SMV10B) at ratios shown in Table 1 below, and the contents were uniformly mixed by stirring for 10 minutes, followed by drying in an oven at 110° C. for 2 hours. The thus obtained granulated product was pulverized in a mortar, and the pulverized product was passed through a sieve having an aperture of 700 μm to regulate particle diameters. Thus, resin-coated granulated particles A to C were produced. The ratios shown in Table 1 below are ratios adjusted so that the resin-coated granulated particles A to C each satisfy “water-soluble resin volume/particle volume=2” (i.e., ratios adjusted so that the particles were coated with the water-soluble resin in an amount twice as large as the volume of the particles).

TABLE 1
(Parts by weight)

| | A | B | C |
|---|---|---|---|
| Polyethylene particles | 100 | — | — |
| Glass beads | — | 100 | — |
| Spherical stainless-steel particles | — | — | 100 |
| Water-soluble resin | 450 | 150 | 50 |
| Ion-exchanged water | 230 | 80 | 25 |

Next, the following materials were prepared as materials for foam.

[Polyol]

Polyether polyol (GL-3000, manufactured by Sanyo Chemical Industries, Ltd.)

[Foam Stabilizer]

SRX 274 DL, manufactured by Dow Corning Toray Co., Ltd.

[Foaming Agent]

Ion-exchanged water

[Catalyst (1)]

TEDA-L33, manufactured by Tosoh Corporation

[Catalyst (2)]

TOYOCAT-ET, manufactured by Tosoh Corporation

[Isocyanate (TDI)]

Coronate T-80, manufactured by Tosoh Corporation

[Isocyanate (MDI)]

Millionate MR-200, manufactured by Tosoh Corporation

### Example 1

100 Parts by weight of the polyol, 2 parts by weight of the foam stabilizer, 1.6 parts by weight of the foaming agent, 0.5 parts by weight of the catalyst (1), and 0.1 parts by weight of the catalyst (2) were preliminarily mixed in advance. To the mixture, 118 parts by weight of resin-coated granulated particles A, 19.29 parts by weight of the isocyanate (TDI), and 9.65 parts by weight of the isocyanate (MDI) were added, and the whole was stirred and cast into a mold. After that, heat treatment at 80° C. for 20 minutes was performed to foam and cure urethane. After that, the resultant was removed from the mold, and air was blown against the surface of the resultant foam to crush the foam. Thus, foam of interest having a foaming ratio of 10 times (dimensions: 40 mm×160 mm×30 mm thick) was obtained.

### Example 2

Foam having a foaming ratio of 10 times was obtained in the same manner as in Example 1 except that 147 parts by weight of the resin-coated granulated particles B were used in place of the resin-coated granulated particles A.

### Example 3

Foam having a foaming ratio of 10 times was obtained in the same manner as in Example 1 except that 240 parts by weight of the resin-coated granulated particles C were used in place of the resin-coated granulated particles A.

### Comparative Example 1

Foam having a foaming ratio of 10 times was obtained in the same manner as in Example 1 except that the resin-coated granulated particles A were not blended.

Each of the thus obtained foams of the Examples and the Comparative Example was repeatedly compressed while the foam was immersed in water. After that, the foam was dried in an oven at 60° C. for 12 hours, and the resultant was used as a sample.

Each of the thus obtained samples of the Examples and the Comparative Example was evaluated for its properties in accordance with the following criteria. The results are shown together in Table 2 below. “Particle weight/urethane weight” in Table 2 is the weight of the particles calculated from their blending ratio, relative to the weight of the urethane.

<<Vibration Amount>>

One end of an iron plate measuring 40 mm×220 mm×1.2 mm thick was fixed, and a commercially available accelerometer was attached to the unfixed side thereof. Then, the sample was bonded to the iron plate. After that, the iron plate was hammered so that a constant force was applied thereto, and a vibration amount (dB) was measured when the vibration frequency of the accelerometer was 400 Hz or 800 Hz.

<<Sound Absorption Coefficient>>

The sample was punched into a cylindrical shape having a diameter of 30 mm and a thickness of 20 mm, and the resultant was subjected to the measurement of sound absorption coefficients (%) at 500 Hz, 1,000 Hz, and 2,000 Hz in conformity with JIS A 1405 (2007).

TABLE 2

| | | | Com- | | | |
|---|---|---|---|---|---|---|
| | | | parative | Example | Example | Example |
| | | | Example 1 | 1 | 2 | 3 |
| Particle weight/urethane | | | — | 0.27 | 0.63 | 1.44 |
| weight | | | | | | |
| Vibration | 400 | Hz | 55 | 52 | 48 | 42 |
| amount (dB) | 800 | Hz | 51 | 51 | 50 | 46 |
| Sound | 500 | Hz | 12% | 13% | 12% | 12% |
| absorption | 1,000 | Hz | 20% | 26% | 22% | 21% |
| coefficient | 2,000 | Hz | 47% | 80% | 56% | 50% |

As apparent from the results of Table 2, the samples of the Examples have lower vibration amounts and higher sound absorption coefficients as compared to the sample of the Comparative Example. Thus, the samples of the Examples are found to be capable of achieving both of a vibration countermeasure and a sound countermeasure, and capable of taking a countermeasure against sounds ranging widely from a low frequency to a high frequency. Herein, vibration and sound were separately measured, and there was no significant difference in sound absorption coefficient at 500 Hz between each of the samples of the Examples and the sample of the Comparative Example. However, it has been actually confirmed that the configuration of each of the Examples can achieve a sound countermeasure at 500 Hz by a vibration countermeasure.

A cross-section of one of the samples of the Examples was observed with a scanning electron microscope (manufactured by Hitachi, Ltd., SEMEDXTYPEN, magnification: 100 times). As a result, it was found that the coating of each of the particles in the foam had been removed, and many bell-like structures were found in the foam (see FIG. 2). In addition, it was confirmed that the pore diameters of the bell-like structures reflected the particle diameters of the resin-coated granulated particles used as a material therefor, and the bell-like structures communicated toward the surface of the sample.

Further, a scanning electron microscope photograph was taken of a cross-section of each of the samples of the Examples, the 20 largest cells were sampled from cells that did not form the bell-like structures, and an average value for their cell diameters was defined as a foamed cell diameter. As a result, it was found that each of the samples had a foamed cell diameter of from 400 μm to 500 μm. In the measurement of the cell diameters, for each of oval cells, a value obtained by dividing the sum of its longest diameter and shortest diameter by 2 was defined as the cell diameter.

Although specific embodiments of the present disclosure have been described in the Examples above, the Examples are for illustrative purposes only and are not to be construed as limitative. It is intended that various modifications apparent to a person skilled in the art fall within the scope of the present disclosure.

The method of producing vibration damping and sound absorbing foam of the present disclosure is suitable as a method of producing vibration damping and sound absorbing foam to be used as, for example, vibration damping and sound absorbing foam for housing, vibration damping and sound absorbing foam for an automobile, vibration damping and sound absorbing foam for OA equipment, vibration damping and sound absorbing foam for a railroad, or vibration damping and sound absorbing foam for a road or a bridge.

### REFERENCE SIGNS LIST

1 foam
1a foam surface
1b, 1c cell
2 fine particle

1. A method of producing vibration damping and sound absorbing foam formed of foam and fine particles present inside the foam so as to form bell-like structures in the foam, the method comprising the following steps [I] to [III] in the stated order:
[I] a step of producing fine particles, each having a surface coated with a coating material capable of being dissolved in at least one liquid selected from the group consisting of water and a solvent;
[II] a step including mixing the coated fine particles into a material for foam, and producing foam from the mixture; and
[III] a step of immersing the foam in the at least one liquid selected from the group consisting of the water and the solvent to remove the coating of each of the fine particles in the foam by dissolution in the liquid.

2. The method of producing vibration damping and sound absorbing foam according to claim 1, wherein the material for the foam comprises at least one material selected from the group consisting of ether polyurethane and ester polyurethane.

3. The method of producing vibration damping and sound absorbing foam according to claim 1, wherein the fine particles comprise at least one selected from the group consisting of metal fine particles, resin fine particles, and inorganic fine particles.

4. The method of producing vibration damping and sound absorbing foam according to claim 1, wherein the liquid comprises water.

5. The method of producing vibration damping and sound absorbing foam according to claim 1, wherein the coating material comprises at least one selected from the group consisting of a rubber, a resin, and an ionic inorganic material each of which is capable of being dissolved in the at least one liquid selected from the group consisting of the water and the solvent.

6. The method of producing vibration damping and sound absorbing foam according to claim 1, further comprising, between the step [II] and the step [III], a step of blowing air against a surface of the foam to crush the foam.

7. The method of producing vibration damping and sound absorbing foam according to claim 1, wherein the step [III] is performed by repeatedly compressing the foam in the liquid.

8. The method of producing vibration damping and sound absorbing foam according to claim 1, wherein a weight ratio of the weight of the fine particles to the weight of the foam is from 0.1 to 200.

9. The method of producing vibration damping and sound absorbing foam according to claim 1, wherein the fine particles have a specific gravity of from 0.9 to 12.

10. The method of producing vibration damping and sound absorbing foam according to claim 1, wherein the fine particles each have a particle diameter of from 10 μm to 1,000 μm.
